(19) United States
(12) Patent Application Publication
(10) Pub. No.: US 2017/0005468 A1
(43) Pub. Date: Jan. 5, 2017

(54) POWER SUPPLY AND DISTRIBUTION SYSTEM AND AN ASSOCIATED METHOD THEREOF

(71) Applicant: General Electric Company, Schenectady, NY (US)

(72) Inventor: Pierluigi Tenca, Munich (DE)

(21) Appl. No.: 14/755,214

(22) Filed: Jun. 30, 2015

(51) Int. Cl. H02J 3/00; H01F 41/00; H01F 38/00; H01F 27/26; H01F 30/10

(52) U.S. Cl. CPC H02J 3/00; H01F 27/266; H01F 30/10; H01F 38/00; H01F 41/00

(57) ABSTRACT

A power supply and distribution system is presented. The power supply and distribution system includes a subsea magnetic device disposed in a predefined pattern along a wall of a subsea vessel. The subsea magnetic device includes a first conductor, a second conductor, and a plurality of cores, where at least one of the first conductor and the second conductor extends through at least one of the plurality of cores. A first geometrical dimension of the subsea magnetic device is substantially larger than a second geometrical dimension or a third geometrical dimension of the subsea magnetic device. Further, the power supply and distribution system includes a power converter coupled to the subsea magnetic device.

### BACKGROUND

Embodiments of the present invention relates generally to a power supply and distribution system, and more specifically to a subsea magnetic device installed in a subsea vessel for use in a subsea production facility.

A reliable power supply and distribution system is important for subsea production facilities. Various industrial components such as a subsea transformer, a subsea switchgear, subsea variable speed drives, and a power control and communication system are employed in the subsea production facility for electrical power supply and distribution. These industrial components are placed in a subsea vessel in deep water far below surface of the sea. In general, the subsea transformer is employed for providing power to equipment, such as boosters, pumps, compressors, pipeline heating systems, electrical distribution systems, frequency converters, and wave hubs.

Typically, subsea transformers are bulky and non-flexible structures. Moreover, the subsea transformers are traditionally positioned proximate to a longitudinal axis of the subsea vessel. Due to such a positioning of the subsea transformer, the subsea transformer occupies lot of the space inside the subsea vessel. As a result, minimal space remains in the subsea vessel to accommodate other industrial components. Moreover, the conventional subsea transformers require a dedicated cooling system to adequately cool the transformer. The use of a dedicated cooling system increases the size, cost, and complexity of the subsea transformer.

Therefore, there is a need for an enhanced subsea magnetic device.

### BRIEF DESCRIPTION

In accordance with aspects of the present disclosure, a power supply and distribution system is presented. The power supply and distribution system includes a subsea magnetic device disposed in a predefined pattern along a wall of a subsea vessel. The subsea magnetic device includes a first conductor, a second conductor, and a plurality of cores. At least one of the first conductor and the second conductor extends through at least one of the plurality of cores. A first geometrical dimension of the subsea magnetic device is substantially larger than a second geometrical dimension or a third geometrical dimension of the subsea magnetic device. Further, the power supply and distribution system includes a power converter coupled to the subsea magnetic device.

In accordance with another aspect of the present disclosure, a method for installing a power supply and distribution system is presented. The method involves disposing a subsea magnetic device in a predefined pattern along a wall of a subsea vessel. Disposing the subsea magnetic device involves disposing a plurality of cores and disposing at least one of a first conductor and a second conductor extending through at least one of the plurality of cores. A first geometrical dimension of the subsea magnetic device is substantially larger than a second geometrical dimension or a third geometrical dimension of the subsea magnetic device. Furthermore, the method involves coupling a power converter to the subsea magnetic device.

In accordance with yet another aspect of the present disclosure, a method for operation of a subsea magnetic device employed in a power supply and distribution system is presented. The method of operation involves providing a current to at least one of a first conductor and a second conductor of the subsea magnetic device through a power converter. The subsea magnetic device is disposed in a predefined pattern along a wall of a subsea vessel. The subsea magnetic device further includes a plurality of cores, where at least one of the first and second conductors extends through at least one of the plurality of cores. A first geometrical dimension of the subsea magnetic device is substantially larger than a second geometrical dimension or a third geometrical dimension of the subsea magnetic device. Also, the method involves generating a first magnetic field due to the current flowing through at least one of the first and second conductors. In addition, the method involves interacting the first magnetic field with a second magnetic field generated from at least one of the plurality of cores.

### DRAWINGS

These and other features, aspects, and advantages of the present specification will become better understood when the following detailed description is read with reference to the accompanying drawings in which like characters represent like parts throughout the drawings, wherein:

FIG. 1 is a block diagram of an exemplary power supply and distribution system in a subsea production facility in accordance with certain embodiments of the present invention;

FIGS. 2-6 are diagrammatical representations of different embodiments of a subsea magnetic device;

FIG. 7 is a diagrammatical representation of one embodiment of a subsea magnetic device;

FIG. 8 is a diagrammatical representation of another embodiment of a subsea magnetic device;

FIG. 9 is a diagrammatical representation of yet another embodiment of a subsea magnetic device;

FIG. 10 is a diagrammatical representation of an embodiment of a subsea magnetic device;

FIGS. 11-13 are diagrammatical representations of different embodiments of mounting a subsea magnetic device in a subsea vessel;

FIG. 14 is a diagrammatical representation of a portion of a subsea vessel along with a portion of a subsea magnetic device in accordance with one exemplary embodiment;

FIG. 15 is a diagrammatical representation of a cross section of a subsea vessel along with a subsea magnetic device in accordance with an exemplary embodiment;

FIG. 16 is a diagrammatical representation of an electrical subsystem employing the subsea magnetic device in accordance with an exemplary embodiment; and

FIG. 17 is a flow chart illustrating a plurality of steps involved in an exemplary method for operation of a subsea magnetic device used in a subsea production facility in accordance with certain embodiments of the present invention.

### DETAILED DESCRIPTION

Unless defined otherwise, technical and scientific terms used herein have the same meaning as is commonly understood by one of ordinary skill in the art to which this specification belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean one, some, or all of the listed items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. Furthermore, the terms “circuit”, “circuitry”, and “controller” may include either a single component or a plurality of components, which are either active and/or passive and are connected or otherwise coupled together to provide the described function. Also, the term “operatively coupled” as used herein includes wired coupling, wireless coupling, electrical coupling, magnetic coupling, radio communication, software based communication, or combinations thereof.

As will be described in detail hereinafter, various embodiments of an exemplary power supply and distribution system in a subsea production facility and method of installing a power supply and distribution system in a subsea production facility are disclosed. Specifically, a subsea magnetic device employed in the power supply and distribution system in a subsea production facility is disclosed. In one embodiment, the subsea magnetic device may be an inductor. In another embodiment, the subsea magnetic device may be a subsea transformer. Moreover, by employing the subsea magnetic device as described herein the space inside a subsea vessel may be adequately utilized for other electrical and electronic installations.

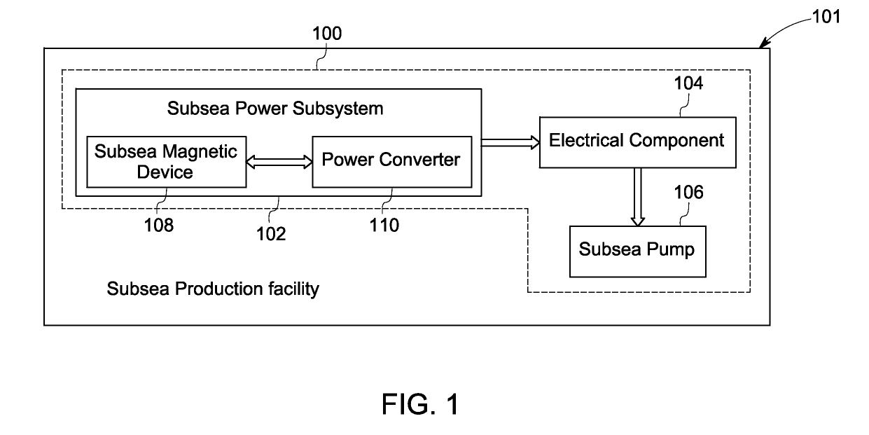

Turning now to the drawings and by way of example in FIG. 1, a block diagram of an exemplary power supply and distribution system 100 in a subsea production facility 101, in accordance with an exemplary embodiment, is disclosed. The power supply and distribution system 100 includes a subsea power system 102, an electrical component 104, and a subsea pump 106. The subsea power system 102 includes a subsea magnetic device 108 and a power converter 110 operatively coupled to the subsea magnetic device 108. In accordance with embodiments of the present invention, the subsea magnetic device 108 is a long and flexible structure.

The power converter 110 may include an alternating current (AC) to direct current (DC) converter, a DC to DC converter, a DC to AC converter, or the like. Electric power is fed via the subsea magnetic device 108 and the power converter 110 to an electrical component 104. In one embodiment, the electrical component 104 may be a motor. The electrical component 104 is operatively coupled to the subsea pump 106 and configured to operate the subsea pump 106.

Furthermore, the subsea magnetic device has a first geometrical dimension, a second geometrical dimension, and a third geometrical dimension. The first geometrical dimension of the subsea magnetic device 108 is substantially larger than a second geometrical dimension or a third geometrical dimension. In one embodiment, the first geometrical dimension, the second geometrical dimension, and the third geometrical dimension of the subsea magnetic device 108 are measured in same measurement unit. In one non-limiting example, the first geometrical dimension is at least five times the second geometrical dimension or the third geometrical dimension of the subsea magnetic device 108. In one embodiment, the first geometrical dimension is a length of the subsea magnetic device 108, the second geometrical dimension is a breadth of the subsea magnetic device 108, and the third geometrical dimension is a height of the subsea magnetic device 108.

In addition, the plurality of cores includes a flexible core, a rigid core, or a combination thereof. In one embodiment, the flexible core is disposed along a whole length of at least one of the first and second conductors and a rigid core may be disposed over the flexible core. However, in another embodiment, the flexible core is disposed along a part of the length of the at least one of the first and second conductors. In yet another embodiment, the flexible core and the rigid core may be alternately disposed along the length of the at least one of the first and second conductors.

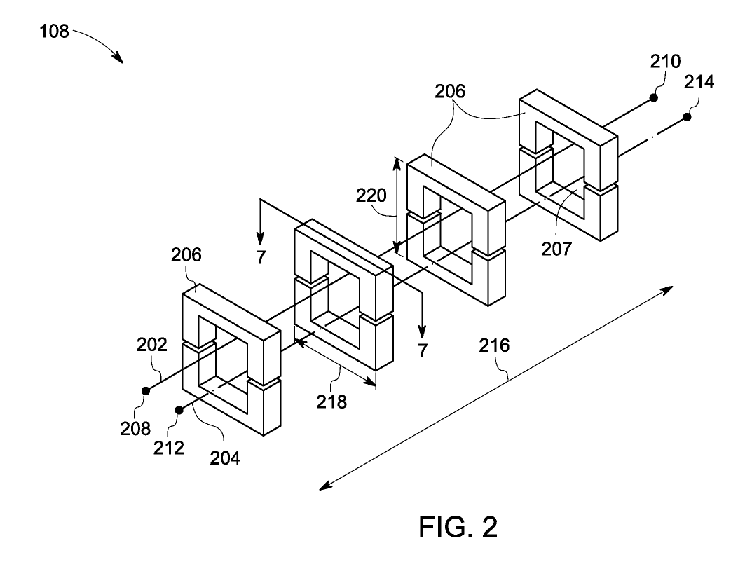

FIG. 2 represents a diagrammatic illustration of the subsea magnetic device 108 in accordance with an exemplary embodiment. The subsea magnetic device 108 includes a first conductor 202 and a second conductor 204. The first conductor 202 is disposed proximate to the second conductor 204. In the illustrated embodiment, the first conductor 202 and the second conductor 204 are disposed parallel to each other. The first conductor 202 is electromagnetically coupled to the second conductor 204.

Furthermore, the subsea magnetic device 108 includes a plurality of cores 206 spaced apart from each other. Each of the plurality of cores 206 includes a hole 207. Each core 206 is a rectangular shaped core. The first conductor 202 and the second conductor 204 extend through the holes 207 of the plurality of cores 206. In another embodiment, each of the plurality of cores 206 may include a plurality of holes 207. In yet another embodiment, the plurality of cores 206 is disposed proximate to each other.

Furthermore, a volume of at least one of the plurality of cores 206 is substantially lesser than a volume of the subsea magnetic device 108. In one embodiment, the volume of at least one of the plurality of cores 206 is 20% of the volume of the subsea magnetic device 108. In one example, the volume of each core of the plurality of cores 206 is 20% of the volume of the subsea magnetic device 108.

The subsea magnetic device 108 includes primary terminals 208, 210 and secondary terminals 212, 214. The subsea magnetic device 108 has a first geometrical dimension 216 substantially larger than a second geometrical dimension 218 or a third geometrical dimension 220. In one embodiment, the first geometrical dimension 216 is representative of a length of the subsea magnetic device 108, the second geometrical dimension 218 is representative of a breadth, and a third geometrical dimension 220 is representative of a height of the subsea magnetic device 108.

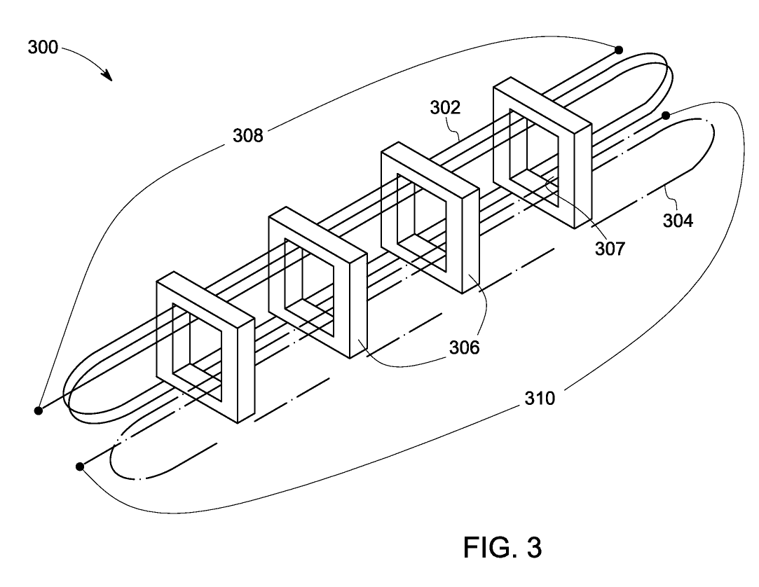

FIG. 3 represents a diagrammatic illustration of a subsea magnetic device 300 in accordance with another exemplary embodiment. The subsea magnetic device 300 includes a first conductor 302, a second conductor 304, and a plurality of cores 306 spaced apart from each other. Each of the plurality of cores 306 includes a hole 307. Each core 306 is a rectangular shaped core. The first conductor 302 and the second conductor 304 extend through the holes 307 of the plurality of cores 306. The first conductor 302 and the second conductor 304 are wound around the plurality of cores 306 to form one or more turns around the plurality of cores 306. The turns ratio of the subsea magnetic device 300 is a ratio of the number of times the second conductor 304 passes through the plurality of cores 306 to the number of times the first conductor 302 passes through the plurality of cores 306. Accordingly, the turns ratio of the subsea magnetic device 300 of FIG. 3 is 2/3. A voltage transformation ratio of the subsea magnetic device 300 is determined based on the turns ratio. The first conductor 302 is electromagnetically coupled to the second conductor 304. Reference numeral 308 represents a primary terminal and reference numeral 310 represents a secondary terminal.

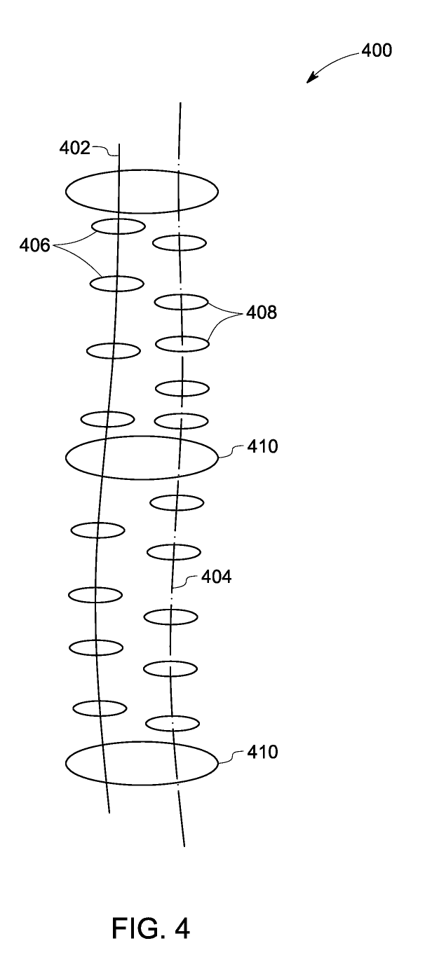

FIG. 4 represents a diagrammatic illustration of a subsea magnetic device 400 in accordance with another exemplary embodiment. The subsea magnetic device 400 includes a first conductor 402 and a second conductor 404 extending through a plurality of first cores 406, a plurality of second cores 408, and a plurality of third cores 410. In particular, the first conductor 402 extends through the first cores 406 and the third cores 410. The second conductor 404 extends through the second cores 408 and the third cores 410. The cores 406, 408, 410 are circular shaped cores.

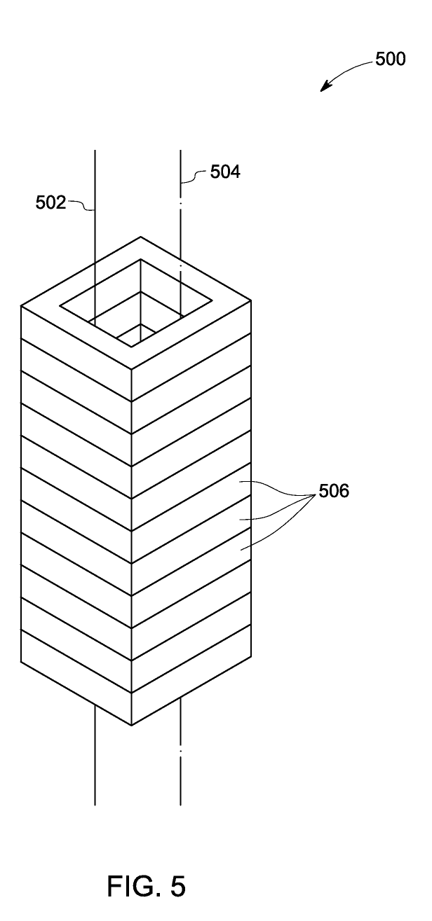

FIG. 5 represents a diagrammatic illustration of a subsea magnetic device 500 in accordance with another exemplary embodiment. The subsea magnetic device 500 includes a first conductor 502, a second conductor 504, and a plurality of cores 506. The second conductor 504 is disposed proximate to the first conductor 502. The first and the second conductors 502, 504 extend through the plurality of cores 506. The plurality of cores 506 are mechanically coupled to each other. The cores 506 may be coupled to each other via an adhesive material, a fastening means, or a combination thereof. With reference to FIGS. 2-5, the subsea magnetic devices 108, 300, 400, 500 are subsea transformers.

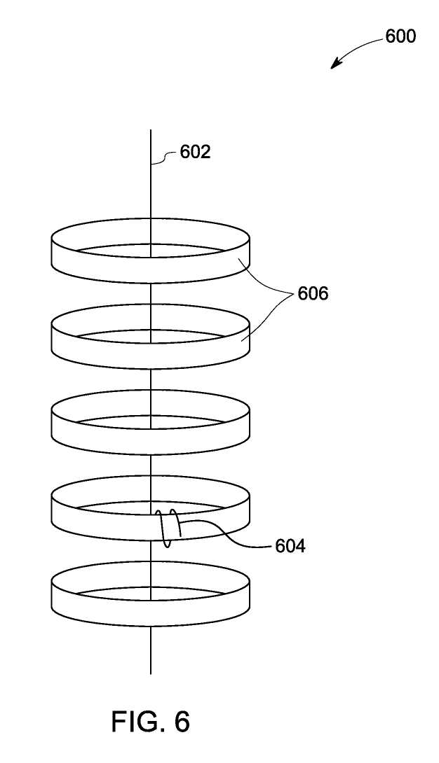

FIG. 6 represents a diagrammatic illustration of a subsea magnetic device 600 in accordance with another exemplary embodiment. The subsea magnetic device 600 includes a first conductor 602 extending through a plurality of cores 606. The subsea magnetic device 600 further includes a second conductor 604 having a substantially smaller length compared to the first conductor 602. The second conductor 604 passes through only one of the plurality of cores 606. As a result, the electromagnetic coupling between the first conductor 602 and the second conductor 604 is negligible. The subsea magnetic device 600 is an inductor.

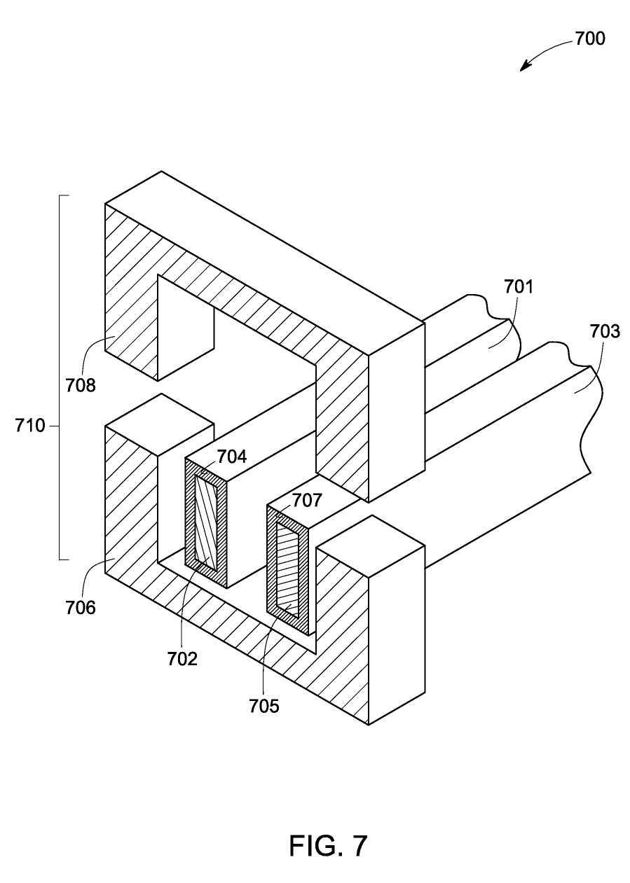

FIG. 7 represents a diagrammatic illustration of a portion of a subsea magnetic device 700 in accordance with another exemplary embodiment. The subsea magnetic device 700 includes a first conductor 701 and a second conductor 703. Each of the first and second conductors 701, 703 may be a cable. The first conductor 701 and the second conductor 703 include respective copper bars 702, 705 surrounded by respective multi-layered insulations 704, 707. In another embodiment, each of the first and second conductors 701, 703 may include a central copper conductor and a main insulation disposed coaxially on the periphery of the central copper conductor. Further, a cable insulating jacket may be disposed coaxially around the periphery of the main insulation.

The subsea magnetic device includes a first half-core 706 and a second half-core 708 which together form a core 710. In one embodiment, the first half-core 706 is mechanically coupled to the second half-core 708. The core 710 is a rectangular shaped core and is made of a ferromagnetic material. The first and second conductors 701, 703 extend through the first and second half-cores 706, 708.

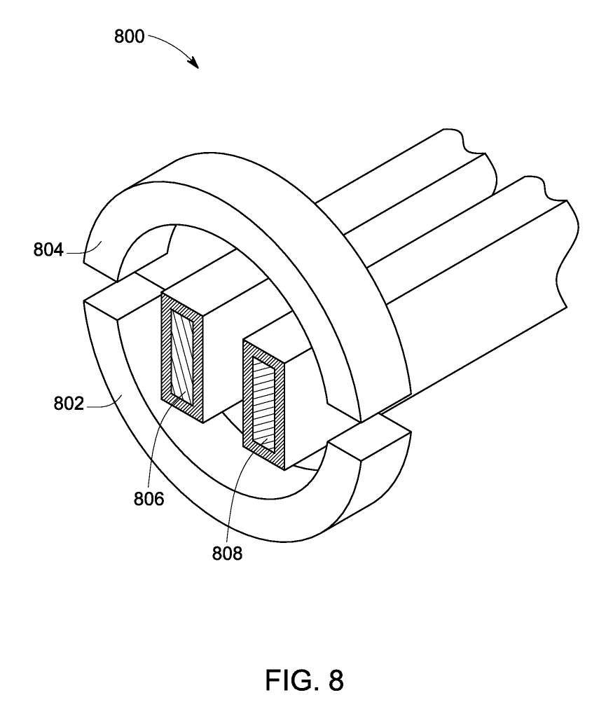

FIG. 8 represents a diagrammatic illustration of a subsea magnetic device 800 in accordance with another exemplary embodiment. The subsea magnetic device 800 includes a first half core 802 and a second half-core 804. The first half-core 802 may be mechanically coupled to the second half-core 804 to form a circular shaped core made of a ferromagnetic material. The first and second conductors 806, 808 extend through the circular shaped core.

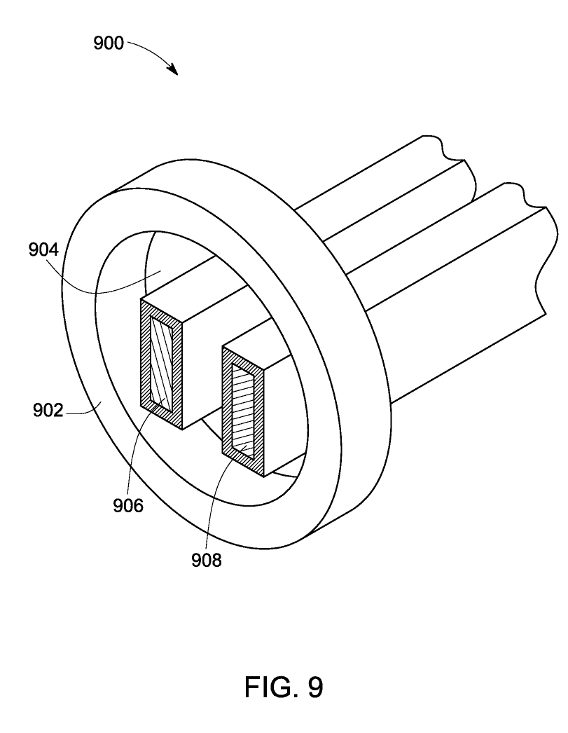

FIG. 9 represents a diagrammatic illustration of a subsea magnetic device 900 in accordance with another exemplary embodiment. The subsea magnetic device 900 includes a circular core 902 having a central circular hole 904. The subsea magnetic device 900 includes first and second conductors 906, 908 extending through the hole 904.

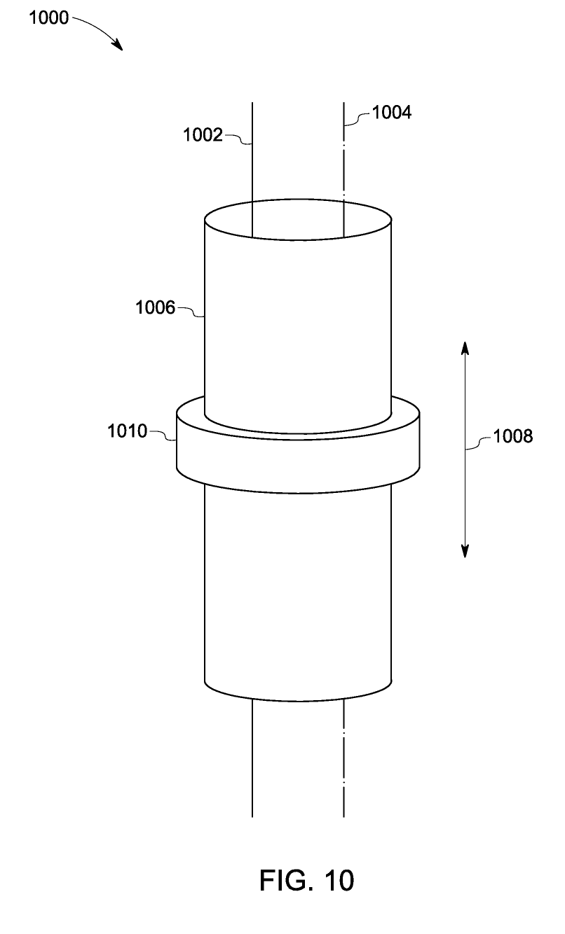

FIG. 10 represents a diagrammatic illustration of a subsea magnetic device 1000 in accordance with another exemplary embodiment. The subsea magnetic device 1000 includes a first conductor 1002 and a second conductor 1004. The first conductor 1002 is disposed in proximate and parallel to the second conductor 1004. Each of the first and second conductors 1002, 1004 is a cable. Further, the subsea magnetic device 1000 includes a flexible core 1006 and a rigid core 1010. The flexible core 1006 is disposed along a longitudinal direction around the first and second conductors 1002, 1004. A rigid core 1010 is disposed along a longitudinal direction 1008 around a portion of an outer periphery the flexible core 1006. In another embodiment, the flexible core 1006 and the rigid core 1010 are disposed along a longitudinal direction 1008 adjacent to each other around a portion of the outer periphery of the first and second conductors 1002, 1004. In yet another embodiment, the flexible core 1006 is disposed along an entire length of at least one of the first and second conductors 1002, 1004 and a rigid core 1010 may be disposed over the flexible core 1006. In another embodiment, the flexible core 1006 is disposed along a portion of the length of the at least one of the first and second conductors 1002, 1004.

With continued reference to FIG. 10, the rigid core 1010 is made of a ferromagnetic material, including but not limited to iron. The flexible core 1006 constitutes a polymer and powdered iron or iron oxide. In one embodiment, the flexible core 1006 includes powdered iron or iron oxide combined with rubber or rubber-like materials.

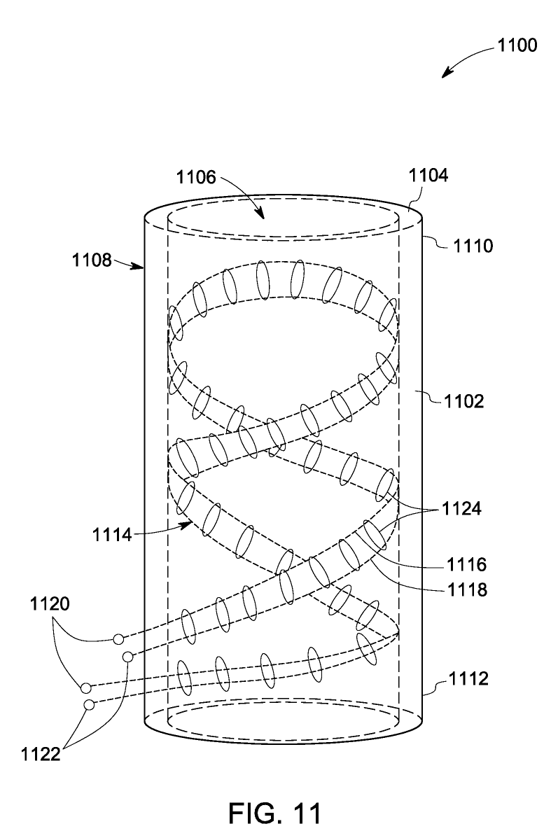

FIG. 11 is a diagrammatical representation 1100 of a subsea vessel 1102 having a cylindrical shape. The subsea vessel 1102 is configured to hold different electrical components and a subsea magnetic device 1114 to be employed in a subsea production facility. The subsea vessel 1102 includes a wall 1104 having an inner peripheral surface 1106 and an outer peripheral surface 1108.

The subsea magnetic device 1114 includes a first conductor 1116 disposed proximate to a second conductor 1118. The two ends of the first conductor 1116 forms a primary terminal 1120. Further, the two ends of the second conductor 1118 forms a secondary terminal 1122. Further, the subsea magnetic device 1114 includes a plurality of cores 1124 disposed spaced apart from each other. The first conductor 1116 and the second conductor 1118 extend through the plurality of cores 1124.

The subsea magnetic device 1114 extends in a helical pattern along the wall 1104 of the subsea vessel 1102. Particularly, the subsea magnetic device 1114 extends in a helical pattern between a lower end 1112 and an upper end 1110, along the inner peripheral surface 1106 of the subsea vessel 1102. The subsea magnetic device 1114 may be spaced apart at a predetermined distance from the inner peripheral surface 1106 or may be in direct contact with the inner peripheral surface 1106 of the subsea vessel 1102.

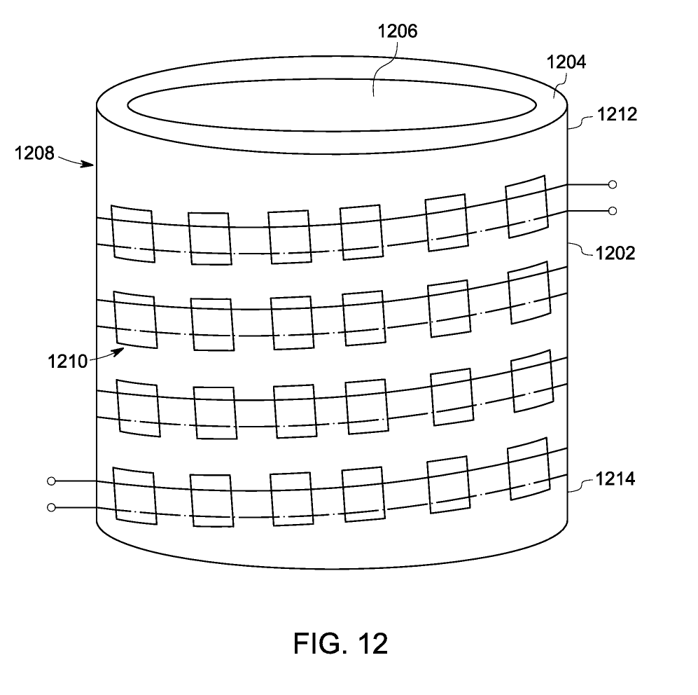

FIG. 12 is a diagrammatical representation of a subsea magnetic device 1210 disposed in a predefined pattern along an outer peripheral surface 1208 of a wall 1204 of a subsea vessel 1202. The subsea vessel 1202 includes a wall 1204 having an inner peripheral surface 1206 and the outer peripheral surface 1208. In particular, the subsea magnetic device 1210 is wound in a helical pattern between an upper end 1212 and a lower end 1214, along the outer peripheral surface 1208 of the subsea vessel 1202. The subsea magnetic device 1210 may be spaced part at a distance from the outer peripheral surface 1208 of the subsea vessel 1202 or may be in direct contact with the outer peripheral surface 1208 of the subsea vessel 1202.

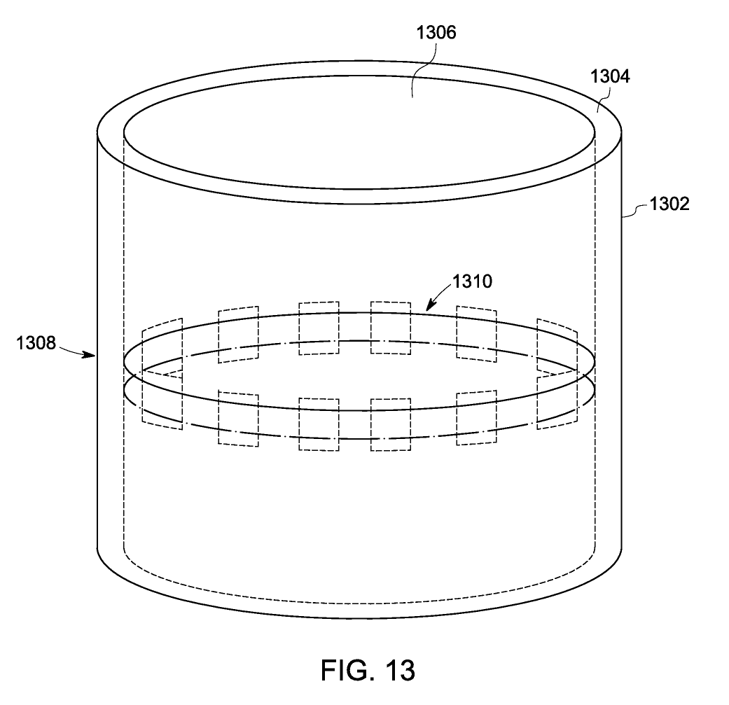

FIG. 13 is a diagrammatical representation of a subsea magnetic device 1310 disposed in a predefined pattern along an inner peripheral surface 1306 of a wall 1304 of a subsea vessel 1302. The wall 1304 of the subsea vessel 1302 includes the inner peripheral surface 1306 and an outer peripheral surface 1308. In particular, the subsea magnetic device 1310 is disposed along a portion of the inner peripheral surface 1306 of the subsea vessel 1302. More particularly, the subsea magnetic device 1310 is disposed in a circular pattern along the inner peripheral surface 1306. The subsea magnetic device 1310 may be in direct contact with the inner peripheral surface 1306 or may be spaced apart at a predetermined distance from the inner peripheral surface 1306.

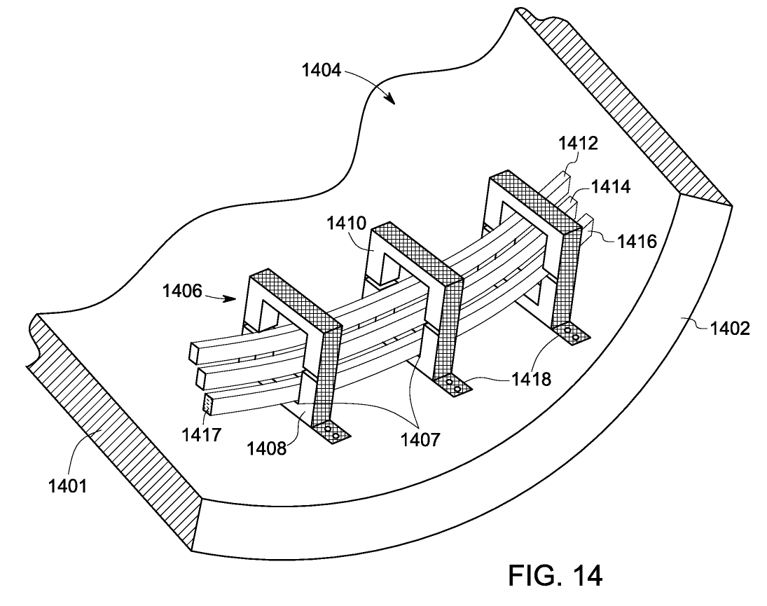

Referring to FIG. 14, a diagrammatical representation of a portion of a subsea vessel 1401 along with a portion of a subsea magnetic device 1406 according to an exemplary embodiment of the present invention. The subsea magnetic device 1406 is disposed along a wall 1402 of the subsea vessel 1401. In particular, the subsea magnetic device 1406 is in direct contact with an inner peripheral surface 1404 of the wall 1402 of the subsea vessel 1401. The subsea magnetic device 1406 is a subsea transformer.

The subsea magnetic device 1406 includes a first conductor 1412 disposed proximate to a second conductor 1414. The first conductor 1412 and the second conductor 1414 are disposed parallel to each other. Furthermore, the first and second conductors 1412, 1414 extend through a plurality of cores 1407.

The plurality of cores 1407 are disposed spaced apart from each other. Specifically, the cores 1407 are disposed sequentially adjacent to each other. The core 1407 includes a first half-core 1408 and a second half-core 1410. The first half-core 1408 may be mechanically coupled to the inner peripheral surface 1404 of the subsea vessel 1401 by a fastening means. The second half core 1410 is held against the first half core 1408 in such a way that the first and second half cores 1408, 1410 surround a portion of length of the first and second conductors 1412, 1414.

The subsea magnetic device 1406 is secured to the inner peripheral surface 1404 of the wall 1402 of the subsea vessel 1401 via a support structure 1418, for example, a C-shaped frame. Also, the first half-core 1408 is held against the second half core 1410 via the support structure 1418.

In addition, the subsea magnetic device 1406 includes a thermal conducting pipe 1416 extending through the plurality of cores 1407. The thermal conducting pipe 1416 is configured to circulate a coolant fluid 1417. The thermal conducting pipe 1416 facilitates heat dissipation for cooling the subsea magnetic device 1406. In one embodiment, the coolant fluid 1417 is sea water.

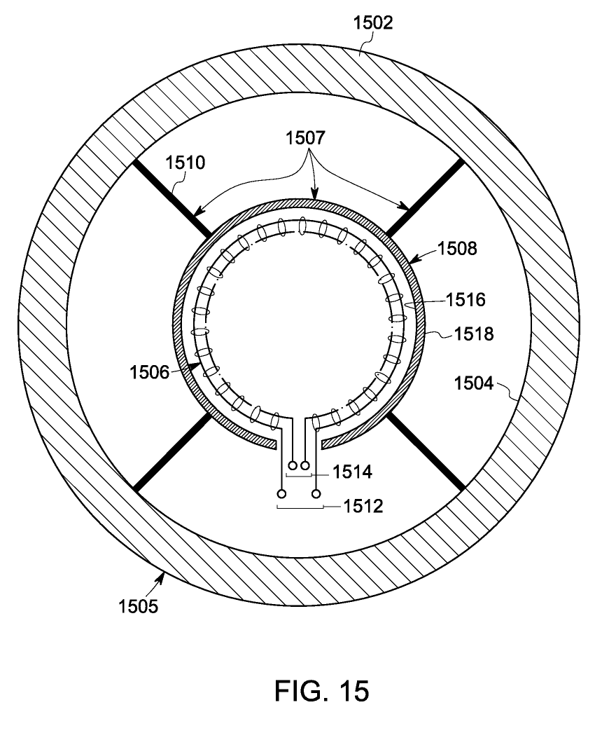

FIG. 15 is a diagrammatical representation of a cross section of a subsea vessel 1502 along with a subsea magnetic device 1506. The subsea magnetic device 1506 is disposed along an inner peripheral surface 1504 of the subsea vessel 1502. The subsea magnetic device 1506 is a subsea transformer disposed in a circular pattern. Reference numerals 1512 and 1514 are representative of two terminals of the subsea magnetic device 1506.

Specifically, the subsea magnetic device 1506 is secured to the inner peripheral surface 1504 of the subsea vessel 1502 via a support structure 1507. The support structure 1507 includes a rail 1508 and a plurality of beams 1510. The rail 1508 is a ring-like structure disposed along the inner peripheral surface 1504 of the subsea vessel 1502. The plurality of beams 1510 are spaced apart from each other and extend from an outer peripheral surface 1518 of the rail 1508 to the inner peripheral surface 1504 of the subsea vessel 1502. The subsea magnetic device 1506 is disposed along an inner peripheral surface 1516 of the rail 1508. The subsea magnetic device 1506 is mechanically coupled to the rail 1508 and disposed spaced apart from the subsea vessel 1502. In another embodiment, the subsea magnetic device 1506 may be disposed similarly along an outer peripheral surface 1505 of the subsea vessel 1502. Also, in one embodiment, the subsea magnetic device 1506 may be disposed space apart from the inner or outer peripheral surface 1504. 1505 in a helical pattern.

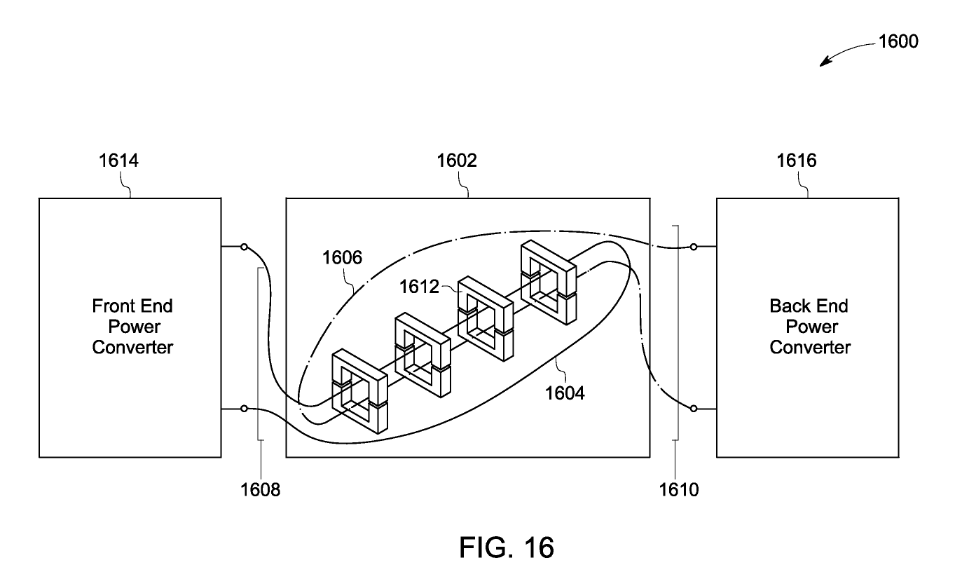

Referring to FIG. 16, a diagrammatical representation of a subsea power subsystem 1600 employing a subsea magnetic device 1602 in accordance with an exemplary embodiment is illustrated. The subsea power subsystem 1600 includes a subsea magnetic device 1602 having a first conductor 1604 disposed proximate to a second conductor 1606. Furthermore, the subsea magnetic device 1602 includes a plurality of cores 1612 disposed spaced apart from each other. The first and second conductors 1604, 1606 extend through the plurality of cores 1612. The subsea magnetic device 1602 is a subsea transformer.

Two end points of the first conductor 1604 forms a first terminal 1608 and two end points of the second conductor 1606 forms a second terminal 1610. A front end power converter 1614 is electrically coupled to the first terminal 1608 and a back end power converter 1616 is electrically coupled to the second terminal 1610. The front end and back end power converters 1614, 1616 may include an AC to DC converter, an AC to AC converter, a DC to AC converter, and the like. Electric power is supplied from a source (not shown) via the front end power converter 1614 to the subsea magnetic device 1602. Consequently, the power is transformed by the subsea magnetic device 1602 and then further transferred to the back end power converter 1616. The power is then transferred from the back end power converter 1616 to an electrical component, such as a motor which may be coupled to a pump.

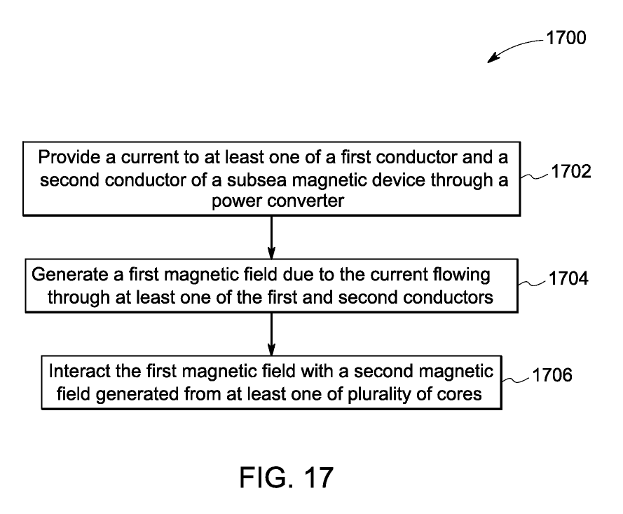

FIG. 17 is a flow chart 1700 illustrating a plurality of steps involved in an exemplary method for operation of a subsea magnetic device in a subsea production facility in accordance with an exemplary embodiment. At block 1702, a current is provided to at least one of a first conductor and a second conductor of the subsea magnetic device through a front end power converter. As discussed herein, the subsea magnetic device is disposed in a predefined pattern along a wall of a subsea vessel. The subsea magnetic device the first conductor disposed proximate to the second conductor and at least one of the first and second conductors extending through at least one of the plurality of cores.

At block 1704, a first magnetic field is generated due to the current flowing through at least one of the first and second conductors. Further, at block 1706, the first magnetic field interacts with a second magnetic field generated from at least one of the plurality of cores. In one embodiment, the first magnetic field from the first and second conductors interacts with the second magnetic field from a core of the plurality of cores. In another embodiment, the first magnetic field from the first and second conductors interacts with the second magnetic field from the plurality of cores.

The various embodiments of a subsea magnetic device used in an exemplary power supply and distribution system in a subsea production facility disclose a flexible and compact device. Since the subsea magnetic device is compact and flexible, the subsea magnetic device may be easily installed in a subsea vessel. The subsea magnetic device may not occupy lot of space inside the subsea vessel. As a result, adequate space may be available in the subsea vessel to accommodate other electrical components.

While the specification has been described with reference to exemplary embodiments, it will be understood by those skilled in the art that various changes may be made and equivalents may be substituted for elements thereof without departing from the scope of the specification. In addition, many modifications may be made to adapt a particular situation or material to the teachings of the specification without departing from the essential scope thereof.

What is claimed is:

1. A power supply and distribution system, comprising:
a subsea magnetic device disposed in a predefined pattern along a wall of a subsea vessel, wherein the subsea magnetic device comprises:
a first conductor;
a second conductor;
a plurality of cores, wherein at least one of the first conductor and the second conductor extends through at least one of the plurality of cores;
wherein a first geometrical dimension of the subsea magnetic device is substantially larger than a second geometrical dimension or a third geometrical dimension of the subsea magnetic device; and
a power converter coupled to the subsea magnetic device.

2. The system of claim 1, further comprising a plurality of support structures, wherein the plurality of support structures secures the plurality of cores to the wall of the subsea vessel.

3. The system of claim 2, wherein each of the plurality of cores, comprises a first half-core and a second half-core.

4. The system of claim 3, wherein each of the plurality of support structures, is configured to hold the first half-core against the second half-core of the corresponding core.

5. The system of claim 1, wherein at least one of the plurality of cores, comprises a hole, wherein at least one of the first and second conductors extend through the hole of the at least one core.

6. The system of claim 1, wherein the predefined pattern is a helical pattern.

7. The system of claim 1, wherein the predefined pattern is a circular pattern.

8. The system of claim 1, wherein the subsea magnetic device comprises a transformer.

9. The system of claim 1, wherein the subsea magnetic device comprises an inductor.

10. The system of claim 1, wherein the first geometrical dimension is at least five times the second or third geometrical dimensions of the subsea magnetic device.

11. The system of claim 1, wherein the subsea magnetic device is disposed in the predefined pattern along an inner peripheral surface of the wall.

12. The system of claim 1, wherein the subsea magnetic device is disposed in the predefined pattern along an outer peripheral surface of the wall.

13. The system of claim 1, wherein the plurality of cores comprises a rectangular shaped core, a circular shaped core, or a combination thereof.

14. The system of claim 1, wherein the first geometrical dimension, the second geometrical dimension, and the third geometrical dimension of the subsea magnetic device have a same measurement unit.

15. The system of claim 1, wherein a volume of at least one of the plurality of cores is substantially less than a volume of the subsea magnetic device.

16. The system of claim 15, wherein the volume of at least one of the plurality of cores is 20% of the volume of the subsea magnetic device.

17. The system of claim 1, wherein the plurality of cores comprise a flexible core, a rigid core, or a combination thereof.

18. The system of claim 17, wherein at least one of the flexible core or the rigid core is disposed along a longitudinal direction of at least one of the first and second conductors.

19. A method for installing a power supply and distribution system, comprising:
disposing a subsea magnetic device in a predefined pattern along a wall of a subsea vessel, wherein disposing the subsea magnetic device comprises:
disposing a plurality of cores;
disposing at least one of a first conductor and a second conductor extending through at least one of the plurality of cores;
wherein a first geometrical dimension of the subsea magnetic device is substantially larger than a second geometrical dimension or a third geometrical dimension of the subsea magnetic device; and
coupling a power converter to the subsea magnetic device.

20. The method of claim 19, further comprising disposing the first conductor proximate to the second conductor.

21. The method of claim 20, further comprising disposing a thermal conducting pipe configured to circulate a coolant fluid, proximate to the first and second conductors.

22. The method of claim 19, further comprising securing the plurality of cores to the wall of the subsea vessel via a plurality of support structures.

23. The method of claim 19, further comprising winding at least one of the first conductor and the second conductor around at least one core of the plurality of cores to form one or more turns around the at least one core of the plurality of cores.

24. A method for operation of a subsea magnetic device employed in a power supply and distribution system, comprising:
providing a current to at least one of a first conductor and a second conductor of the subsea magnetic device through a power converter, wherein subsea magnetic device is disposed in a predefined pattern along a wall of a subsea vessel, wherein the subsea magnetic device further comprises a plurality of cores, wherein at least one of the first and second conductors extend through at least one of the plurality of cores; wherein a first geometrical dimension of the subsea magnetic device is substantially larger than a second geometrical dimension or a third geometrical dimension of the subsea magnetic device;
generating a first magnetic field due to the current flowing through at least one of the first and second conductors; and
interacting the first magnetic field with a second magnetic field generated from at least one of the plurality of cores.

25. The method of claim 24, further comprising generating an electromagnetic coupling between the first conductor and the second conductor.
